(19) United States
(12) Patent Application Publication
(10) Pub. No.: US 2025/0122826 A1
(43) Pub. Date: Apr. 17, 2025

(54) ROTARY ENGINE

(71) Applicant: LI Liangui, Co. Limerick (IE)

(72) Inventor: LI Liangui, Co. Limerick (IE)

(21) Appl. No.: 18/293,411

(22) PCT Filed: Oct. 15, 2021
(86) PCT No.: PCT/IB2021/000523

§ 371 Date: Jan. 30, 2024

(51) Int. Cl. F02B 55/02; F02B 53/00

(52) U.S. Cl. CPC F02B 55/02; F02B 53/00

(57) ABSTRACT

A rotary engine only have 2 processes (intake and combustion) and can finish those 2 processes in 1 cycle, and the press is always perpendicular with shaft, estimate this 2 ways will increase the efficiency from around 20% up to at least 60%.

This engine is simple and stable, it has engine body; rotor with piston fast on it which drives shaft rotates; when shutter is open the piston can go through the throat, and when shutter is close which make a close working chamber with engine body/rotor/piston; and auxiliaries like gas feed/control, air compress/feed/control, cooling systems etc.

### CROSS-REFERENCE TO RELATED APPLICATIONS

This Application claims priority from a patent application filed in WIPO having Patent Application No. PCT/IB2021/000523 filed on Oct. 15, 2021.

### TECHNICAL FIELD

This invention is about the internal combustion engine, compare to the traditional 4-stroke (intake;compression: combustion: exhaust) engine, finish 1 cycle in 2 rotations, this invention only has 2-stroke (intake: combustion) and finish 1 cycle in 1 rotation, try to reduce the power loss, improve the fuel efficiency.

### BACKGROUND

Here from website: The four-stroke engine is the most common types of internal combustion engines and is used in various fields. A four stroke engine delivers one power stroke for every two cycles of the piston (or four piston strokes). There is an animation of a four-stroke engine and further explanation of the process below.
1. Intake stroke: The piston moves downward to the bottom, this increases the volume to allow a fuel-air mixture to enter the chamber.
2. Compression stroke: The intake valve is closed, and the piston moves up the chamber to the top. This compresses the fuel-air mixture. At the end of this stroke, a spark plug provides the compressed fuel with the activation energy required to begin combustion.
3. Power Stroke: As the fuel reaches the end of it's combustion, the heat released from combusting hydrocarbons increases the pressure which causes the gas to push down on the piston and create the power output.
4. Exhaust stroke: As the piston reaches the bottom, the exhaust valve opens. The remaining exhaust gas is pushed out by the piston as it moves back upwards. The thermal efficiency of these gasoline engines will vary depending on the model and design of the vehicle. However in general, gasoline engines convert 20% of the fuel (chemical energy) to mechanical energy.
   END from Internet

Only power stroke is useful, the other 3 strokes need the inertia flywheel or the power stroke of other cylinders to overcome the resistance, this limits the fuel efficiency.

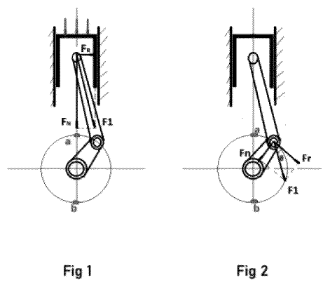

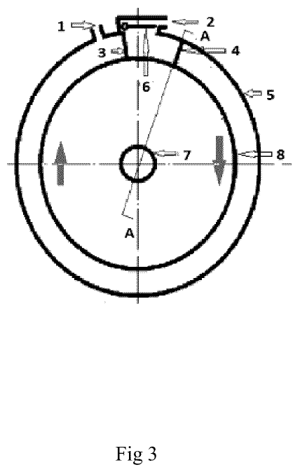

For a traditional engine, when fuel burns (power stroke, from a to b) the high pressure push the piston downwards, then push the connector to drive crankshaft rotates. But because the force is not perpendicular with the crankshaft, so there is many power loss. show as FIG. 1 & FIG. 2.

### SUMMARY OF THE INVENTION

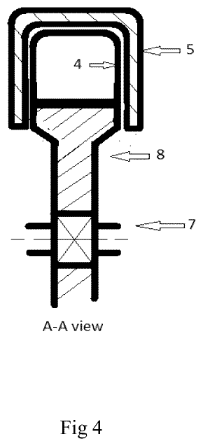

FIG. 3 & 4 shows the simplified schematic of rotary engine, this engine has those parts:
1. outlet, always open
2. inlet, control by timer belt
3. throat, which stops 6 (shutter) when it at the close position
4. piston, which fasten to 8 (rotor) and fine matched to 5 (engine body) & 8 (rotor)
5. engine body
6. shutter, which has 2 positions: close position (throat position) & open position (rest position), droved by timer belt
7. shaft
8. rotor, which fine matched to the 5 (engine body). when shutter is at close position (throat position)/inlet valve closed, the 8 (rotor) & 6 (shutter) & 4 (piston) & 5 (engine body) form a closed working chamber, combustion happens here, push the piston to drive rotor rotate as the red arrows.

### BRIEF DESCRIPTION OF THE INVENTION

The invention try to improve the fuel efficiency in two ways:
1, reduce the 4-stroke to 2-stroke;
2, ensure the force is perpendicular to the shaft always.

To understand how this engine works, we pick up one cycle during normal working

[symbol]

Step 1: start from FIG. 5, at this time piston just passed shutter runaway area, shutter ready to close (means shutter turns to the throat position), inlet valve opens and compressed air fills in. after shutter closed (at the throat position) fills the air with atomized fuel;

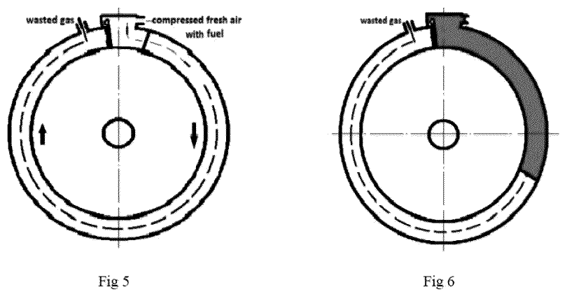

Step 2: As show in FIG. 6, inlet valve close, combustion begin, fuel burns and the pressure inside the working chamber rises up, push piston and then drive rotor rotates, power stroke begin.

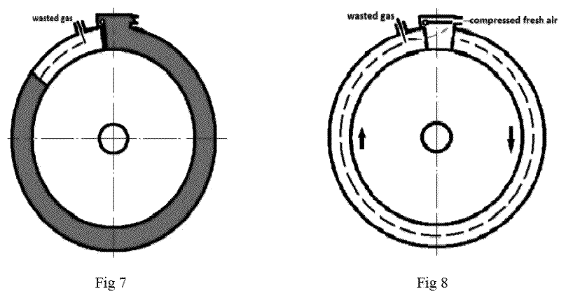

Step 3: when power stroke is going to finish, the pressure inside working chamber is not much higher than the exhaust pressure, the piston moves to the position as FIG. 7, at this time inlet valve keep closed, shutter ready to open to let piston go through.

Step 4: show as FIG. 8, shutter is open and at it's rest position, inlet valve keep closed, piston go through the throat. and go to step 1.

### Advantages of this Invent

1. Simple but reliable.

2. The force is perpendicular on the rotary radius always, that means more power output, and finish one cycle in one rotation, that means more efficiency.

3. Easy to get bigger power, traditional engine always need to balance the power with the radius of crankshaft.

4. Working smoother than traditional engine, because no side force on chamber wall. means lower noise lower heat but longer lifetime.

### The Difficulties

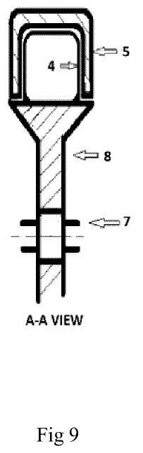

The difficulty is sealing. There are two positions need to seal it well: 1, between shutter and rotor at the throat position: 2, between engine body with rotor and piston. Here are some ways to resolve:
1. The layout of working chamber sealing. FIG. 9 shows another layout, the shape depend on engineering.
2. It was difficult to make sure those moving parts fine match to stable parts before, but we have CNC now.
3. Choose different expand ratio materials for those parts, the smaller for engine body and shutter but the bigger for rotor and piston is an good idea. When engine heats up rotor & piston expands a little larger than engine body & shutter. After a short time running-in, all the contact areas will be very fine match with each other. As mentioned above this engine has no side force, so it will be fine match for a long time.
4. Carve patterns on the rotor/piston is anther good way for sealing. After a short time running-in, the carbon deposit, metal shavings and lubricating oil will accumulates in this patterns, make it like sealing.

1. The invention rotary engine, characterized by at least one power output unit, comprising a outlet, inlet, throat, piston, engine body, shutter, shaft, rotor, the auxiliaries not showed:
The rotor is firmly connected to engine output shaft:
The rotor is fine matched to the engine body, and fine sealed:
The piston is fastened to the rotor and fine matched to the engine body and fine sealed. the function of the piston is divide the working chamber (formed by shutter/rotator/engine body/piston) with the outlet and drive the rotator rotates:
The shutter is droved by timer belt which droved by the shaft in turn to make sure the exact open/close time. When shutter at the rest position, the piston can go through the throat to finish 1 cycle and start next cycle; when shutter at the throat position, the shutter working with engine body & rotor & piston form a sealed working chamber.

2. The invention rotary engine, characterized by rotor is part of working chamber, which with shutter & piston & engine body together form a working chamber. when fuel combustion inside, push the piston and then drive rotor rotates.

3. The invention rotary engine characterized by, the rotor act as flywheel when only 1 power output unit exist.

4. The invention rotary engine, characterized by finish 1 cycle in 1 rotation.

5. The invention rotary engine, characterized by the force is perpendicular the rotary radius always, this ensure the maximum power output.

6. The invention rotary engine, characterized by, the medium inside the working chamber also can be steam or water, like a turbine.
